(19) United States
(12) Patent Application Publication
(10) Pub. No.: US 2026/0118711 A1
(43) Pub. Date: Apr. 30, 2026

(54) ELECTRO-OPTICAL DEVICE, PROJECTOR, AND ELECTRONIC APPARATUS

(71) Applicant: SEIKO EPSON CORPORATION, Tokyo (JP)

(72) Inventor: Toshiki TANI, SAPPORO-SHI (JP)

(73) Assignee: SEIKO EPSON CORPORATION, Tokyo (JP)

(21) Appl. No.: 19/370,667

(22) Filed: Oct. 27, 2025

(30) Foreign Application Priority Data
Oct. 28, 2024 (JP) 2024-188830

(51) Int. Cl. G02F 1/1333; G02F 1/1339; G02F 1/1343; G03B 21/00

(52) U.S. Cl. CPC G02F 1/133345; G02F 1/1339; G02F 1/13439; G03B 21/006

(57) ABSTRACT

An electro-optical device includes a first substrate and a second substrate disposed to face each other and bonded to each other via a sealing material, a liquid crystal layer sandwiched between the first substrate and the second substrate, an insulating layer provided at a liquid crystal layer side of the first substrate, a first pixel electrode and a second pixel electrode provided at a liquid crystal layer side of the insulating layer, a counter electrode provided at a liquid crystal layer side of the second substrate to face the first pixel electrode and the second pixel electrode, to which a first potential is applied, and an electrode provided to protrude from the insulating layer toward the liquid crystal layer in an inter-pixel area between the first pixel electrode and the second pixel electrode in a plan view, to which a second potential different from the first potential is applied.

The present application is based on, and claims priority from JP Application Serial Number 2024-188830, filed October 28, 2024, the disclosure of which is hereby incorporated by reference herein in its entirety.

### BACKGROUND

### Technical Field

The present disclosure relates to an electro-optical device, a projector, and an electronic apparatus.

### Related Art

In an electro-optical device including a liquid crystal display device formed using an inorganic material, a photochemical reaction occurs in a liquid crystal layer in a display area of the liquid crystal display device by irradiation with illumination light, and impurities containing ionic substances may be desorbed from an evaporated film of liquid crystal. The impurities desorbed from the evaporated film may move in the display area along the oblique direction of the evaporated film obliquely evaporated with respect to the base material and accumulate in the corner portions of the display area in the plan view to form display spots. The display quality of the electro-optical device deteriorates due to the impurities moving in the display area and the impurities accumulated in the corner portions of the display area.

For example, JP-A-2017-078792 discloses a technique of moving impurities from a display area to a non-display area by applying alternating-current signals at different phases from each other to electrodes provided in a peripheral area as the non-display area around the display area.

JP-A-2017-078792 is an example of the related art.

In the electro-optical device of the related art including the electro-optical device disclosed in JP-A-2017-078792, the impurities can be moved to the non-display area of the liquid crystal display device or the impurities can be captured in the non-display area as described above, but the impurities may not be completely removed from the display area and the deterioration of display quality may not be suppressed. Therefore, measures for removing impurities generated in a display area from a pixel region overlapping pixel electrodes in the plan view are desired.

### SUMMARY

An electro-optical device according to an aspect of the present disclosure includes a first substrate and a second substrate disposed to face each other, a liquid crystal layer sandwiched between the first substrate and the second substrate, an insulating layer provided at a liquid crystal layer side of the first substrate, a first pixel electrode and a second pixel electrode provided at a liquid crystal layer side of the insulating layer, a counter electrode provided at a liquid crystal layer side of the second substrate to face the first pixel electrode and the second pixel electrode, to which a first potential is applied, and an electrode provided to protrude from the insulating layer toward the liquid crystal layer in an inter-pixel area between the first pixel electrode and the second pixel electrode in a plan view, to which a second potential different from the first potential is applied. In the electro-optical device according to the aspect of the present disclosure, the electrode forms a step in the inter-pixel area.

### BRIEF DESCRIPTION OF THE DRAWINGS

FIG. 1 is a plan view of a liquid crystal display device according to a first embodiment.

FIG. 2 is a cross-sectional view of the liquid crystal display device in FIG. 1 cut along line B1-B2.

FIG. 3 is an equivalent circuit diagram of pixel circuits in a display area of the liquid crystal display device in FIG. 1.

FIG. 4 is a schematic diagram showing potentials of data signals in the liquid crystal display device in FIG. 1.

FIG. 5 is a plan view of an element substrate of the liquid crystal display device in FIG. 1.

FIG. 6 is a cross-sectional view of a display area of the element substrate in FIG. 5 in a direction of arrows along line B3-B4 in FIG. 5.

FIG. 7 is a cross-sectional view of the non-display area of the element substrate of FIG. 5 in directions of arrows along line B5-B6 of FIG. 5.

FIG. 8 is a cross-sectional view showing a behavior in which impurities are captured in the display area of the liquid crystal display device in FIG. 1.

FIG. 9 is a cross-sectional view showing a behavior in which impurities are captured in a non-display area of the liquid crystal display device in FIG. 1.

FIG. 10 is a schematic diagram of a projector of the first embodiment.

FIG. 11 is a cross-sectional view of a display area of an element substrate of a liquid crystal display device according to a second embodiment.

### DESCRIPTION OF EMBODIMENTS

Hereinafter, a liquid crystal display device will be described as an example of an electro-optical device according to an embodiment. In the following drawings, dimensions and scales of the respective portions are appropriately different from those of an actual device. The embodiments described below are preferred specific examples. Unless otherwise stated in the following description, the scope of the present disclosure is not limited to the embodiments described below.

### First embodiment

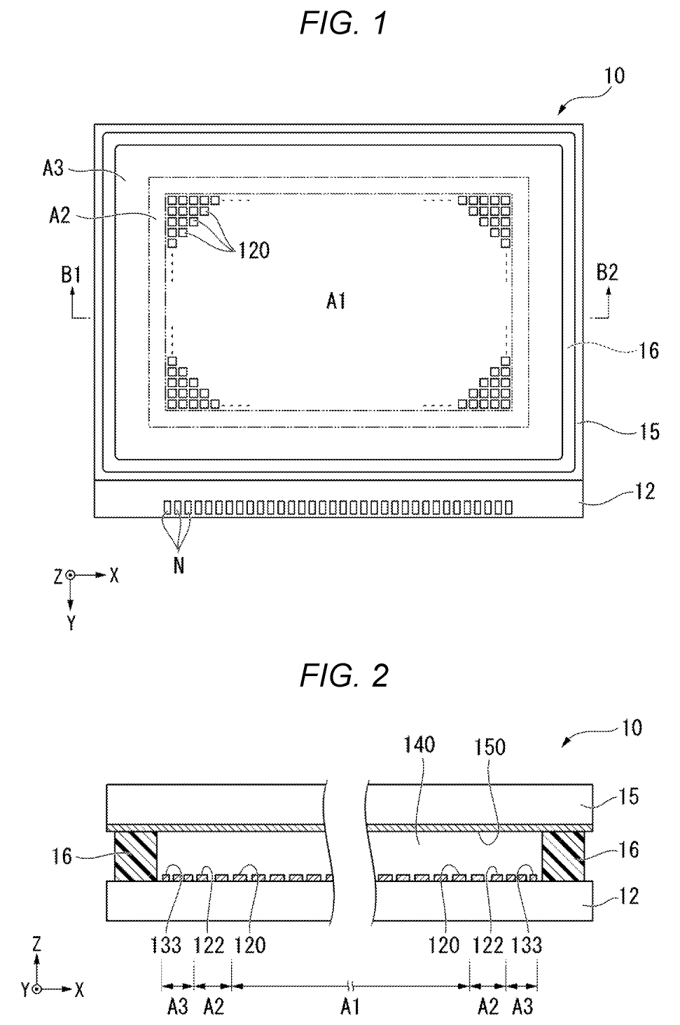

A first embodiment of the present disclosure will first be described with reference to FIGS. 1 to 10.

### Liquid Crystal Display Device

FIG. 1 is a plan view of a liquid crystal display device 10 of the first embodiment. FIG. 2 is a cross-sectional view of the liquid crystal display device 10 cut along line B1-B2 in FIG. 1. As illustrated in FIGS. 1 and 2, in the liquid crystal display device 10, an element substrate 12 and a counter substrate 15 are bonded to each other with a substantially constant thickness by a sealing material 16. For the element substrate 12 and the counter substrate 15, a base material having transmissivity for irradiation light and insulating properties such as optical glass or quartz crystal is used.

A plurality of pixel electrodes 120 are provided on a surface of the element substrate 12 facing the counter substrate 15. The plurality of pixel electrodes 120 are arranged in a matrix along an X direction and a Y direction in a plan view. A region in which the plurality of pixel electrodes 120 are arranged in the plan view is a display area A1. The element substrate 12 corresponds to a first substrate described in What is claimed is. The counter substrate 15 corresponds to a second substrate described in What is claimed is.

The element substrate 12 is provided with a scanning line drive circuit (not illustrated) that supplies a scanning signal to a scanning line 112, a data signal output circuit (not illustrated) that outputs a data signal to a data line 114, and the like. The element substrate 12 is provided with a plurality of terminals N for inputting various signals to the scanning line drive circuit and the data signal output circuit.

The X direction is a direction parallel to one side of the display area A1 having a shape in the plan view, for example, a longitudinal direction, in which the scanning line described later extends. The Y direction is orthogonal to the X direction in the plan view, for example, a lateral direction of the display area A1, in which the data line described later extends. A Z direction is a direction orthogonal to the X direction and the Y direction, and corresponds to a normal direction of the first substrate described in What is claimed is. The plan view refers to a view from one substrate of the element substrate 12 and the counter substrate 15 to the other substrate, a view along the Z direction. A counter electrode 150 is provided on a surface of the counter substrate 15 facing the element substrate 12.

A liquid crystal layer 140 is a layer formed by sandwiching liquid crystal between the element substrate 12 and the counter substrate 15 in the Z direction. The liquid crystal layer 140 is filled with liquid crystal in which long axis directions of liquid crystal molecules are parallel to the Z direction in a state where no voltage is applied, for example, as in the VA (vertical alignment) mode.

Non-display areas A2 and A3 are areas outside the display area A1 and inside the sealing material 16 in the plan view. The non-display areas A2 and A3 have frame shapes that sequentially surrounds the display area A1 in the plan view. That is, in the plan view, the non-display area A2 surrounds the display area A1, and the non-display area A3 surrounds the non-display area A2. Dummy pixel electrodes 122 are provided in the non-display area A2. Columnar upper conductive layers 133 are provided in the non-display area A3. As will be described later, the pixel electrodes 120, the dummy pixel electrodes 122, and the upper conductive layers 133 are formed using indium tin oxide (ITO) of the upper conductive layers 133 deposited in the same process.

In the non-display areas A2 and A3, for example, light-shielding films are provided on at least one of the element substrate 12 and the counter substrate 15 in the plan view. Therefore, the non-display areas A2 and A3 do not contribute to image display. From the display area A1 in which the pixel electrodes 120 are arranged toward an area without the pixel electrodes 120, a difference in presence or absence of the pixel electrodes may appear as a difference in display. Therefore, the dummy pixel electrodes 122 formed in the same manner as the pixel electrodes 120 are provided in the non-display area A2, and a difference in display from the display area A1 is unlikely to appear.

Alignment films (not illustrated) that determine the alignment of the liquid crystal molecules are provided on a surface of the element substrate 12 facing the counter substrate 15 and a surface of the counter substrate 15 facing the element substrate 12.

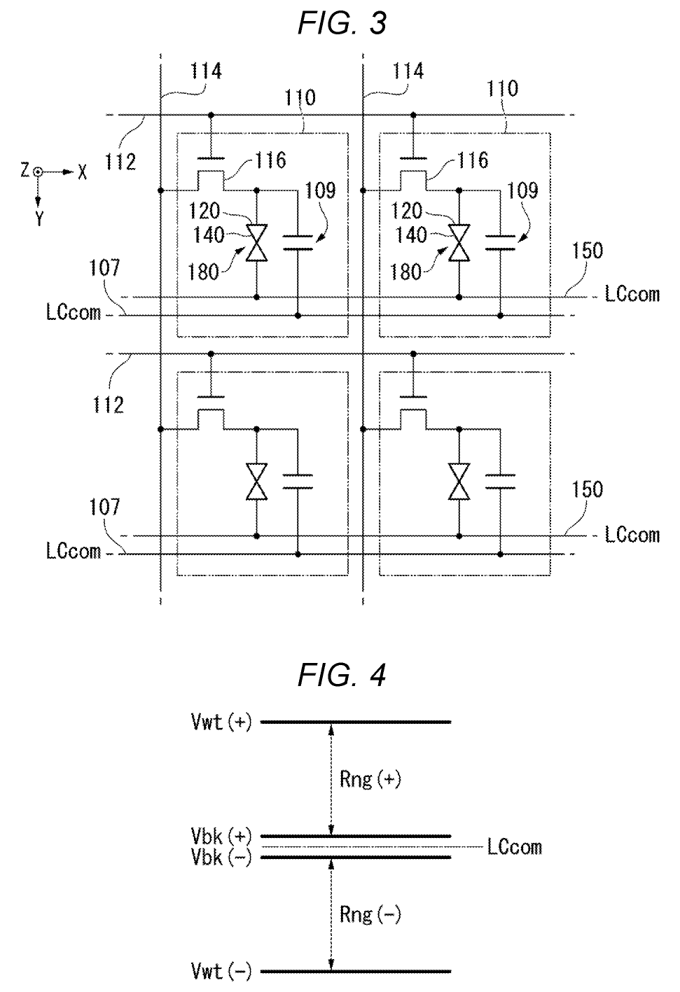

FIG. 3 is an equivalent circuit diagram of pixel circuits 110 in the display area A1. As illustrated in FIG. 3, the pixel circuits 110 are provided corresponding to intersection positions of a plurality of the scanning lines 112 extending in the X direction and a plurality of the data lines 114 extending in the Y direction. The pixel circuit 110 includes a transistor 116 and a liquid crystal element 180.

The transistor 116 is, for example, an N-channel thin film transistor (TFT). In the pixel circuit 110, a gate node of the transistor 116 is coupled to the scanning line 112, a source node of the transistor 116 is coupled to the data line 114, and a drain node of the transistor 116 is coupled to the pixel electrode 120.

In the present description, "coupling" refers to direct or indirect coupling or joining between two or more elements. In the present description, "coupled" includes, for example, a state in which two or more elements are joined directly or via different conductive layers and contact holes in a substrate.

The counter electrode 150 faces the pixel electrode 120 and is maintained at a temporally substantially constant potential LCcom. The potential LCcom corresponds to a first potential described in What is claimed is. The liquid crystal layer 140 is sandwiched between the pixel electrodes 120 and the counter electrode 150. For each pixel circuit 110, the pixel electrode 120, the counter electrode 150, and the liquid crystal layer 140 form the liquid crystal element 180. A storage capacitor 109 is provided electrically in parallel with the liquid crystal element 180. One end of the storage capacitor 109 is coupled to the pixel electrode 120, and the other end of the storage capacitor 109 is coupled to a capacitor line 107. The capacitor line 107 is maintained at a temporally constant potential, for example, the same potential LCcom as that of the counter electrode 150.

The scanning line drive circuit sequentially and exclusively selects the plurality of scanning lines 112 one by one in one frame period, and sets the scanning signal of the selected scanning line 112 at the H level. The data signal output circuit outputs a data signal at a potential corresponding to the gray level to the pixel circuit 110 located on the scanning line 112 selected by the scanning line drive circuit via the data line 114.

In the pixel circuit 110 corresponding to the scanning line 112 in which the scanning signal is at the H level, the transistor 116 is in the on-state, so the data signal is applied to the pixel electrode 120 via the data line 114. Even when the scanning signal is at the L level and the transistor 116 is in the off-state, the data signal is held by the capacity of the liquid crystal element 180 and the storage capacitor 109.

In the liquid crystal element 180, the alignment of the liquid crystal molecules changes in accordance with an electric field generated by the pixel electrodes 120 and the counter electrode 150. The transmittance of the liquid crystal element 180 with respect to light incident on the liquid crystal element 180 changes in accordance with an effective value of a voltage applied to the liquid crystal element 180.

The above-described operation and behavior are similarly executed in the pixel circuit 110 located on the selected scanning line 112. The transmittance of all the liquid crystal elements 180 in the display area A1 is changed according to the gray level by the sequential exclusive selection of the scanning line 112 in one frame period. Thus, an image in one frame period is generated.

In the first embodiment, the liquid crystal element 180 operates in a normally black mode in which the transmittance of the liquid crystal element 180 is the lowest when the applied voltage is zero and the transmittance of the liquid crystal element 180 increases as the applied voltage increases.

In principle, the liquid crystal element 180 is driven by an alternating-current voltage. Specifically, the potential of the data signal is applied such that the positive potential at the higher potential side and the negative potential at the lower potential side are alternately switched, for example, for each period of one frame (V) with reference to the potential LCcom of the counter electrode 150.

FIG. 4 is a schematic diagram illustrating a potential range available for the data signal. The range available for the positive potential is indicated by Rng(+). The range Rng(+) is, for example, from a potential Vwt(+) which is the maximum value of the gray level to the potential Vbk(+) which is the minimum value of the gray level. The range available for the negative potential is indicated by Rng(-). The range Rng(-) is, for example, from a potential Vwt(-) at the maximum value of the gray level to the potential Vbk(-) at the minimum value of the gray level.

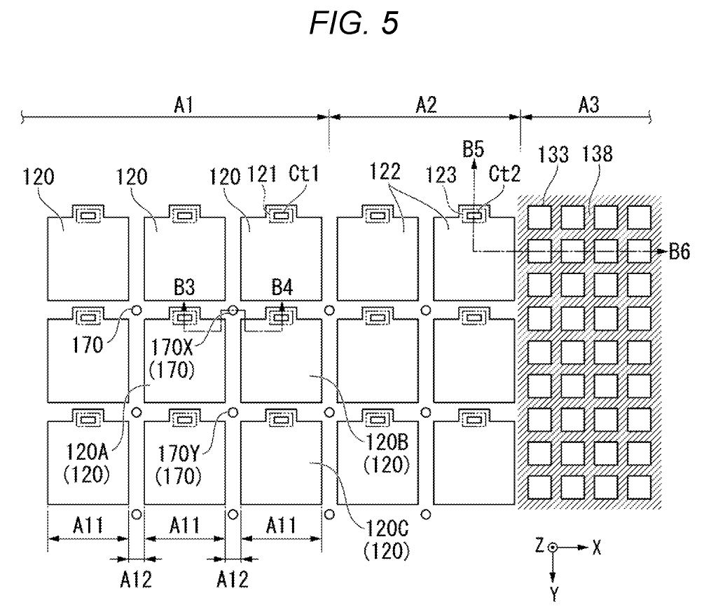

FIG. 5 is a plan view of the element substrate 12 in the display area A1 and the non-display areas A2 and A3 illustrating an arrangement of the pixel electrodes 120, the dummy pixel electrodes 122, and the upper conductive layers 133. As illustrated in FIG. 5, the pixel electrode 120 in the display area A1 is coupled to a wire 191 which is a drain node of the transistor 116 via a coupling electrode 121 which is filled in a contact hole Ct1. The pixel electrode 120 has a substantially square shape in the plan view.

In the display area A1, the plurality of pixel electrodes 120 are arranged at intervals in each of the X direction and the Y direction. The display area A1 is segmented into pixel areas A11 overlapping the pixel electrodes 120 and inter-pixel areas A12 not overlapping the pixel electrodes 120 in the plan view, that is, in the Z direction.

Columnar shield electrodes 170 are provided in the inter-pixel area A12. The shield electrode 170 corresponds to an electrode described in What is claimed is. The shape of the shield electrode 170 in the plan view and the arrangement of the shield electrodes 170 in the inter-pixel area A12 are not particularly limited. The shield electrodes 170 are disposed, for example, in the inter-pixel areas A12 adjacent to two or more pixel electrodes 120 and corner portions of the pixel areas A11 in the plan view.

The shape of the shield electrode 170 in the plan view is, for example, a circle, but may be a polygon including a rectangle. A base conductive layer 171 forming the base of the shield electrode 170 is formed using a conductive material such as tungsten (W) or copper (Cu). An upper conductive layer 172 of the shield electrode 170 is formed using indium tin oxide, for example, similarly to the pixel electrode 120 and the dummy pixel electrode 122.

The shield electrodes 170 may be provided linearly in the plan view so as to extend along the Y direction or provided so as to be scattered along the Y direction, at intervals from the respective pixel electrodes 120A and 120B adjacent to each other in the X direction in the inter-pixel area A12. Similarly, the shield electrodes 170 may be provided linearly in the plan view so as to extend along the X direction or provided so as to be scattered along the X direction, at intervals from the respective pixel electrodes 120 adjacent to each other in the Y direction in the inter-pixel area A12.

One pixel electrode 120 of the pixel electrodes 120, 120 adjacent to each other in the X direction and the Y direction corresponds to a first pixel electrode described in What is claimed is, and the other pixel electrode 120 of the pixel electrodes 120, 120 adjacent to each other in the X direction and the Y direction corresponds to a second pixel electrode described in What is claimed is. For example, the pixel electrode 120A corresponds to the first pixel electrode, and the pixel electrodes 120B and 120C correspond to the second pixel electrodes.

The dummy pixel electrode 122 in the non-display area A2 is formed similarly to the pixel electrode 120 in the display area A1 except that the coupling destination is different.

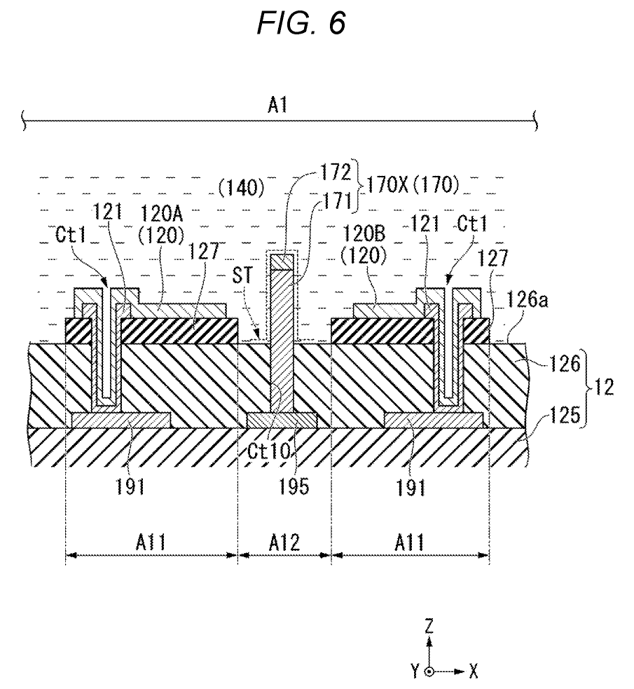

FIG. 6 is a cross-sectional view of the display area A1 of the element substrate 12 of the liquid crystal display device 10, cut along line B3-B4 in FIG. 5. The cross-sectional view is a view cut along a plane orthogonal to a plane including the X direction and the Y direction, for example, a view cut along a plane including the X direction and the Z direction.

In FIG. 6, some insulating layers and some conductive layers close to the liquid crystal layer 140 in the Z direction among a plurality of insulating layers and a plurality of conductive layers provided in the element substrate 12 are illustrated, and a layer structure below, that is, at the opposite side in the Z direction of these insulating layers and conductive layers is omitted. The layer structure below the insulating layer 126 includes a thin film transistor (not illustrated) and the like.

As shown in FIG. 6, a conductive material of wires 191 and 195 is deposited on the insulating layer 125, and the wires 191 and 195 as wires are provided by patterning the deposited conductive layer. The wires 191 and the wires 195 are separated from each other. In the first embodiment, the wires 195 are provided on the insulating layer 125 similarly to the wires 191, but the wires 195 may be provided at a height, that is, at a position in the Z direction different from that of the wires 191 as long as the wires 195 are not in electrical contact with the wires 191.

A potential LHL is applied to the wires 195 and the shield electrodes 170. The potential LHL is different from the potential applied to the pixel electrodes 120. The potential LHL corresponds to a second potential in What is claimed is. The voltage applied to the shield electrode 170 may be either a direct-current voltage or alternating-current voltage, but is preferably a direct-current voltage from the viewpoint of preventing separation of the impurities PM captured by the shield electrode 170 as described later. The voltage value applied to the shield electrode 170 is appropriately set to be substantially constant, and may be changed according to, for example, the amount of the impurities PM captured by the shield electrode 170.

The insulating layer 126 is formed so as to cover the insulating layer 125 and the wires 191 and 195. An insulating layer is formed so as to cover the insulating layer 126. The insulating layer covering the insulating layer 126 contains boron (B) and phosphorus (P), and forms a moisture-proof layer for preventing moisture from entering the liquid crystal layer 140.

The insulating layer covering the insulating layer 126 in the display area A1 is patterned to form an insulating layer 127. In the pixel area A11 of the display area A1, the contact hole Ct1 penetrates the insulating layers 126 and 127 along the Z direction, is opened, and reaches the wire 191. In the inter-pixel area A12 of the display area A1, a contact hole Ct10 penetrates the insulating layers 126 and 127 along the Z direction, is opened, and reaches the wire 195.

After the contact hole Ct1 is formed, a conductive layer is deposited and patterned to form the coupling electrode 121 in the pixel area A11 of the display area A1. The coupling electrode 121 is at least electrically coupled to the wire 191, preferably in direct contact with the wire 191 from above.

After the coupling electrode 121 is provided, a conductive layer is deposited. The conductive layer deposited on the coupling electrode 121 is patterned in the display area A1. The pixel electrodes 120 are formed in the pixel area A11 by patterning the conductive layer described above.

After the contact hole Ct10 is formed, a conductive material is filled, deposited, or grown in the contact hole Ct10, and the base conductive layer 171 of the shield electrode 170 is formed in the inter-pixel area A12 of the display area A1. That is, the bottom end, that is, the end at the opposite side in the Z direction of the base conductive layer 171 is in contact with the wire 195 that is not coupled to the wires 191 and 192. The end, that is, the front end in the Z direction of the base conductive layer 171 protrudes toward the liquid crystal layer 140 at least more than the insulating layer 126 and is located above, that is, in front of the coupling electrode 121 in the Z direction.

The upper conductive layer 172 is formed so as to cover the end of the base conductive layer 171. The upper conductive layer 172 may be formed in the same process as the pixel electrode 120. The upper conductive layer 172 of the shield electrode 170 may be omitted, and the shield electrode 170 may include only the base conductive layer 171.

When the upper conductive layer 172 is provided on the shield electrode 170, the end, that is, the front end in the Z direction of the upper conductive layer 172 protrudes toward the liquid crystal layer 140 at least more than the insulating layer 126, and is located above, that is, in front in the Z direction of the coupling electrode 121. Even when the upper conductive layer 172 is omitted, the end of the base conductive layer 171 of the shield electrode 170 protrudes toward the liquid crystal layer 140 more than the insulating layer 126. That is, the shield electrode 170 forms a step ST in the inter-pixel area A12 of the display area A1.

In the liquid crystal display device 10 of the first embodiment, a surface 126a of the insulating layer 126 in the pixel area A11 of the display area A1 and a surface 126a of the insulating layer 126 in the inter-pixel area A12 are flush with each other. In the present specification, "flush" indicates a state in which accuracy of one or more surfaces is suppressed to be less than a dimension of a manufacturing error of the element substrate 12 by, for example, a polishing process or the like. The height of the protrusion of the shield electrode 170 from the insulating layer 126 and the electrical characteristics of the conductive material forming the shield electrode 170 are appropriately set and selected so that an appropriate potential difference for attracting the impurities PM is generated between the shield electrode 170 and the counter electrode 150 as described later when the potential LHL is applied to the shield electrode.

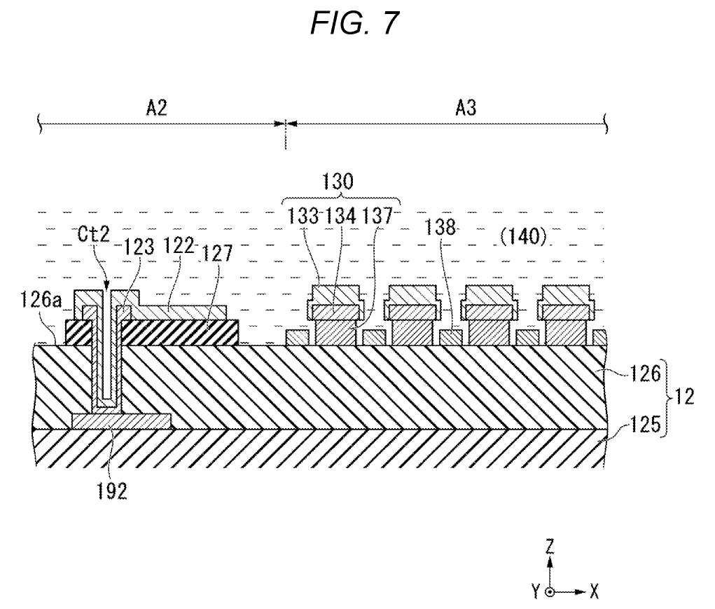

FIG. 7 is a cross-sectional view of the non-display areas A2 and A3 of the element substrate 12 of the liquid crystal display device 10, cut along line B5-B6 in FIG. 5. In FIG. 7, similarly to FIG. 6, some insulating layers and some conductive layers close to the liquid crystal layer 140 in the Z direction among a plurality of insulating layers and a plurality of conductive layers provided on the element substrate 12 are exemplified, and a layer structure below, that is, at the opposite side in the Z direction of these insulating layers and conductive layers is omitted.

As shown in FIG. 7, a conductive material of the wires 192 is deposited on the insulating layer 125, and the wires 192 as wires are provided by patterning the deposited conductive layer. The insulating layer 126 is formed so as to also cover the wires 192.

The insulating layer covering the insulating layer 126 in the non-display area A2 is patterned to form the insulating layer 127. The insulating layer covering the insulating layer 126 in the non-display area A3 is patterned to form a base conductive layer 137 of a columnar body 130.

In the non-display area A2, a contact hole Ct2 penetrates the insulating layers 126 and 127 along the Z direction and is opened. After the contact hole Ct2 is formed, a conductive layer is deposited and patterned to form a coupling electrode 123 which is a coupling electrode in the non-display area A2 and form a middle conductive layer 134 of the columnar body 130 in the non-display area A3. The coupling electrode 123 is at least electrically coupled to the wire 192, preferably in direct contact with the wire 192 from above.

The middle conductive layer 134 is larger than the base conductive layer 137 in the plan view, and is patterned into a shape including the base conductive layer 137 so as to cover the end of the base conductive layer 137. Thus, a part of the middle conductive layer 134 has an overhang structure protruding from the base conductive layer 137 in a cross-sectional view. This increases the capturing force when impurities PN are captured by a shield electrode 138 as described later.

After the middle conductive layer 134 is provided, a conductive layer is deposited. The conductive layer deposited on the middle conductive layer 134 is patterned in the non-display areas A2 and A3. The dummy pixel electrode 122 is formed in the non-display area A2 by patterning the conductive layer described above. Similarly, in the non-display area A3, the upper conductive layer 133 of the columnar body 130 and the shield electrode 138 disposed between the columnar bodies 130 in the plan view and on the insulating layer 126 are formed by the patterning of the conductive layer described above.

In the dummy pixel electrode 122, a coupling destination via the coupling electrode 123 filled in the contact hole Ct2 is a separate wire 192 different from the drain node of the transistor 116. In the first embodiment, the wire 192 is floating without electrical coupling to any configuration.

As illustrated in FIGS. 5 and 7, the upper conductive layer 133 in the non-display area A3 is the uppermost element among the elements forming the columnar body 130. The shape of the upper conductive layer 133 in the plan view is substantially a square like those of the pixel electrode 120 and the dummy pixel electrode 122. The length of one side of the upper conductive layer 133 in the plan view is shorter than the lengths of one sides of the pixel electrode 120 and the dummy pixel electrode 122 in the plan view. In the non-display area A3, the shield electrodes 138 are provided on the element substrate 12 in addition to the columnar bodies 130.

The shield electrode 138 is provided in an area excluding the upper conductive layer 133 in the plan view in the non-display area A3. In other words, the plurality of shield electrodes 138 are provided at intervals in the X direction and the Y direction in the non-display area A3 in a mesh shape in the plan view to surround the upper conductive layers 133.

Although the shield electrode 138 appears to be in contact with the upper conductive layer 133 in the plan view, there is actually a step between the shield electrode 138 and the upper conductive layer 133, and the shield electrode 138 is not in contact with the upper conductive layer 133. The shield electrode 138 is not in contact with the dummy pixel electrode 122 in the non-display area A2. For example, the potential Vwt(-) when the gray level is the maximum value in negative polarity is applied to the shield electrode 138 by a wire (not illustrated).

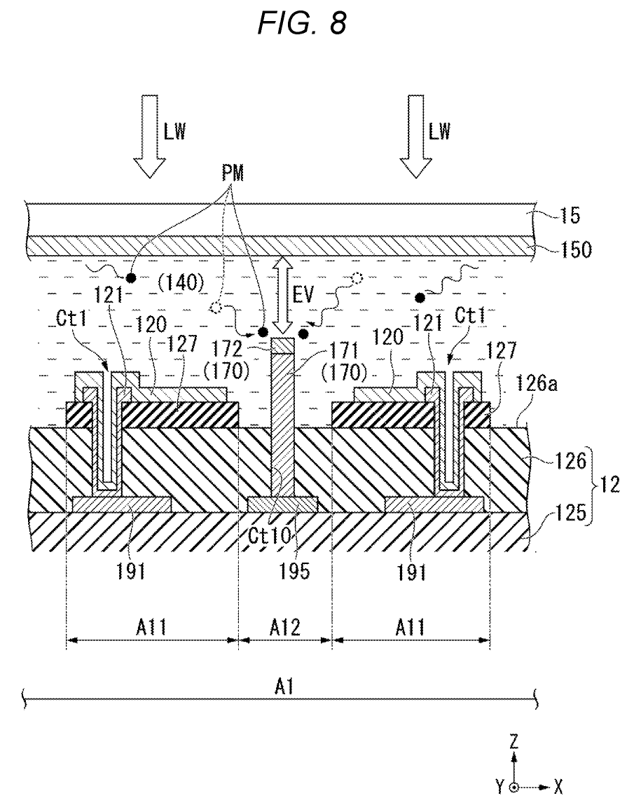

FIG. 8 illustrates a state in which the impurities PM are captured in the display area A1 in the liquid crystal display device 10 of the first embodiment, and corresponds to a cross-sectional view cut along line B3-B4 in FIG. 5. As illustrated in FIG. 8, in a period in which the power supply of the liquid crystal display device 10 is in ON, the potential LCcom is applied to the counter electrode 150 of the counter substrate 15, a potential corresponding to a data signal is applied to the pixel electrodes 120A and 120B of the pixel area A11 of the display area A1 of the element substrate 12, the potential LHL is applied to the shield electrodes 170 as the electrodes in the inter-pixel area A12, a potential difference EV is generated between the shield electrodes 170 and the counter electrode 150, that is, in the normal direction, the Z direction of the shield electrodes 170 and the counter electrode 150, and an electric field is generated in the inter-pixel area A12.

In the display area A1, a photochemical reaction occurs in the liquid crystal layer 140 due to the irradiation light LW incident on the pixel area A11, and the impurities PM containing ionic substances are generated by the photochemical reaction in the liquid crystal layer 140 and the like. In the inter-pixel area A12, the potential difference EV is generated between the shield electrodes 170 and the counter electrode 150 in the Z direction, and the impurities PM generated in the pixel area A11 adjacent to the inter-pixel area A12 in a plane including the X direction and the Y direction are captured. As a result, the impurities PM in the pixel area A11 of the display area A1 are captured in the inter-pixel area A12 on which the irradiation light LW is not incident, shielding of image light (not illustrated) generated by the irradiation light LW and conversion of the irradiation light LW due to the impurities PM is prevented, and deterioration in display quality of the liquid crystal display device 10 is suppressed.

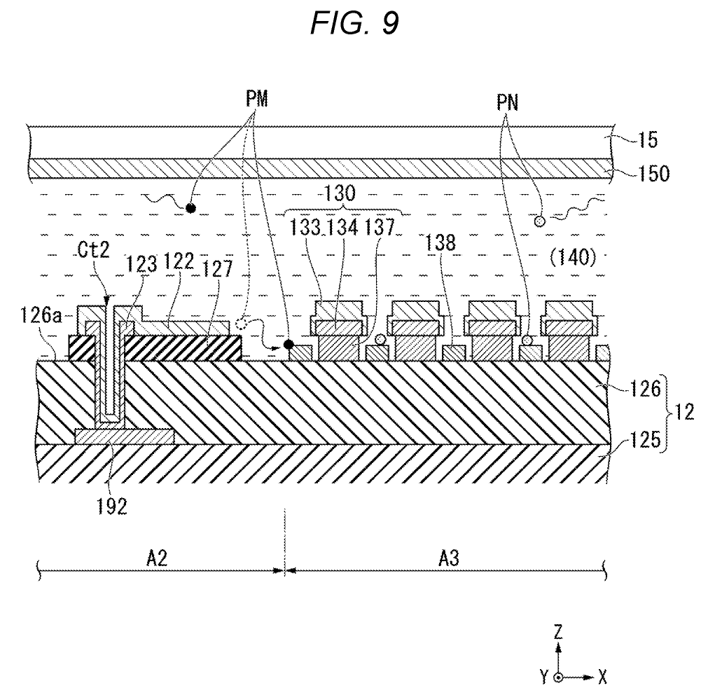

FIG. 9 illustrates a state in which the impurities PM and PN are captured in the non-display areas A2 and A3 in the liquid crystal display device 10 of the first embodiment, and corresponds to a cross-sectional view cut along line B5-B6 in FIG. 5. As illustrated in FIG. 9, in a period in which the power supply of the liquid crystal display device 10 is ON, the potential LCcom is applied to the counter electrode 150 of the counter substrate 15, the potential Vwt is applied to the shield electrodes 138, and an electric field is generated between the shield electrodes 138 and the counter electrode 150 in the Z direction.

In the non-display areas A2 and A3, the impurities PM, which are products of a photochemical reaction or deterioration of the liquid crystal layer 140 and the like, are attracted to a region where an electric field is generated, and as a result, captured by the shield electrodes 138. Also, the impurities PN containing the ionic substances oozing out from the sealing material 16 to the non-display area A3 in the plan view are captured by the shield electrodes 138 and adsorbed to the shield electrodes 138.

In the liquid crystal display device 10 of the first embodiment, the impurities PM in the pixel area A11 in the display area A1 are captured in the inter-pixel area A12 in the display area A1. For example, in a liquid crystal display device of the related art, the shield electrodes 170 are not provided in the inter-pixel area A12, and the shield electrodes 138 are provided only in the non-display area A3.

In the above-described case, it is difficult to sufficiently attract the impurities PM generated in the pixel area A11 of the display area A1 in a wider range in the plan view than the non-display area A3 to the non-display area A3. In this case, it may be possible that the impurities PM in the display area A1 are aggregated in the peripheral portion and the corner portion of the display area A1 in the plan view, and it may be highly possible that the impurities PM are deposited in the peripheral portion and the corner portion of the display area A1 without reaching the shield electrodes 138 in the non-display area A3 to form display spots. In particular, when the display surface of the liquid crystal display device is disposed in parallel to the vertical direction, the impurities PM are likely to be deposited on the bottom end portion and the corner portion of the display area A1, and the possibility that display spots are formed increases. As a result, in the liquid crystal display device of the related art in which the shield electrodes 170 are not provided in the inter-pixel area A12, it is difficult to improve the display quality in the entire display area A1.

As described above, in the liquid crystal display device 10 of the first embodiment, since the impurities PM in the pixel area A11 of the display area A1 are captured in the inter-pixel area A12, the display quality in the entire pixel area A11 of the display area A1 is improved.

### Projector, Electronic Apparatus

Next, a projector will be described as an example of an electronic apparatus including the liquid crystal display device 10 according to the first embodiment.

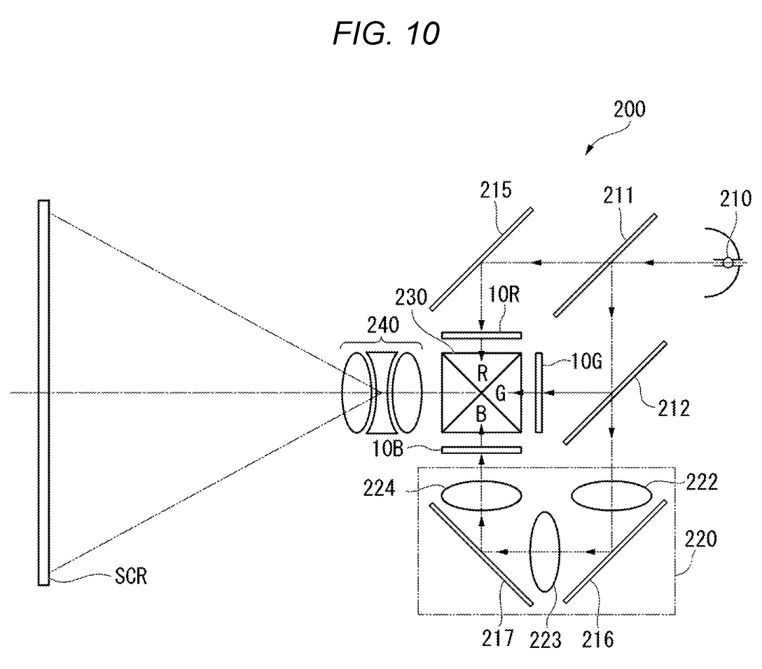

As shown in FIG. 10, a projector 200 is a so-called 3-LCD projector, and includes a light source device 210, two dichroic mirrors 211, 212, three total reflection mirrors 215, 216, 217, and liquid crystal display devices 10R, 10G, and 10B having the same configuration as the liquid crystal display device 10 described above.

The light source device 210 includes a halogen lamp or a white light emitting diode (LED), and emits white light including a red light, a green light, and a blue light. The white light emitted from the light source device 210 is separated into the red light, the green light, and the blue light by the dichroic mirror 211, and is separated into the green light and the blue light by the dichroic mirror 212. The liquid crystal display device 10R is irradiated with the red light by the total reflection mirror 215. The liquid crystal display device 10G is irradiated with the green light emitted from the dichroic mirror 212.

The liquid crystal display device 10B is irradiated with the blue light by the total reflection mirrors 216 and 217. The optical path of the blue light from the dichroic mirror 211 to the liquid crystal display device 10B is longer than the optical path of the red light from the dichroic mirror 211 to the liquid crystal display device 10R and the optical path of the green light from the dichroic mirror 211 to the liquid crystal display device 10G.

In order to suppress a loss of the blue light with respect to the red light and the green light, an incident lens 222 is disposed in the optical path of the blue light between the dichroic mirror 212 and the total reflection mirror 216. A relay lens 223 is disposed between the total reflection mirror 216 and the total reflection mirror 217. An exit lens 224 is disposed between the total reflection mirror 217 and the liquid crystal display device 10B. The incident lens 222, the relay lens 223, and the exit lens 224 form a relay optical system 220.

The liquid crystal display device 10R is driven based on an image data signal input in correspondence with the incident red light, and generates an image light R including a red transmission image. The liquid crystal display device 10G is driven based on an image data signal input in correspondence with the incident green light, and generates an image light G including a green transmission image. The liquid crystal display device 10B is driven based on an image data signal input in correspondence with the incident blue light, and generates an image light B including a blue transmission image.

The image light R emitted from the liquid crystal display device 10R, the image light G emitted from the liquid crystal display device 10G, and the image light B emitted from the liquid crystal display device 10B enter the dichroic prism 230 from different directions. In the dichroic prism 230, the image lights R and B are reflected, and each optical path of the image lights R and B is refracted by 90 degrees in the plan view. In the dichroic prism 230, the image light G is transmitted and travels straight, and the optical path of the image light G overlaps the optical paths of the image lights R and B.

An image light combined by the dichroic prism 230 and emitted in a direction different from the incident directions of the image light R, G, and B is enlarged and projected onto the screen SCR by the projection optical system 240. A color image is displayed on the screen SCR.

Examples of the electronic apparatus including the electro-optical device such as the liquid crystal display device 10 include, in addition to the projector 200, an electronic viewfinder in a head-mounted display, a video camera, an interchangeable lens digital camera, or the like, a display unit of a smart watch, a wearable device, or the like.

The liquid crystal display device (electro-optical device) 10 of the first embodiment described above includes the element substrate (first substrate) 12, the counter substrate (second substrate) 15, the liquid crystal layer 140, the insulating layer 126, the pixel electrode (first pixel electrode) 120A and the pixel electrode (second pixel electrode) 120B, the counter electrode 150, and the shield electrode (electrode) 170. The element substrate 12 and the counter substrate 15 are disposed to face each other and are bonded to each other via the sealing material 16. The liquid crystal layer 140 is sandwiched between the element substrate 12 and the counter substrate 15 in the Z direction. The insulating layer 126 is provided in the display area A1 of the element substrate 12. The pixel electrodes 120A and 120B are provided at the liquid crystal layer 140 side of the insulating layer 126, that is, on the surface 126a of the insulating layer 126 as the front surface in the Z direction. The counter electrode 150 is provided to face the pixel electrodes 120A and 120B in the counter substrate 15, and the potential (first potential) LCcom is applied thereto. The shield electrode 170 is provided to protrude from the insulating layer 126 toward the liquid crystal layer 140 in the inter-pixel area A12 between the pixel electrodes 120A and 120B in the plan view. The potential (second potential) LHL different from the potential LCcom is applied to the shield electrode 170. In the liquid crystal display device 10 of the first embodiment, the step ST is formed by the shield electrode 170 in the inter-pixel area A12.

In the liquid crystal display device 10 of the first embodiment, the potential difference EV between the potential LCcom and the potential LHL is generated between the shield electrode 170 and the counter electrode 150 in the step ST, and the impurities PM generated in the pixel area A11 by the generated electric field can be captured by the electric field and the shield electrode 170. According to the liquid crystal display device 10 of the first embodiment, compared to a configuration in which the impurities PM in the pixel area A11 of the display area A1 are captured in the inter-pixel area A12 and the impurities PM are attracted to the non-display area A3 and the like around the display area A1 as in the related art, the impurities PM can be efficiently removed from the pixel area A11 and a decrease in display quality can be suppressed.

In the liquid crystal display device 10 of the first embodiment, the shield electrode 170 protrudes toward the counter electrode 150 more than the pixel electrodes 120A and 120B.

In the liquid crystal display device 10 of the first embodiment, the shield electrode 170 is disposed closer to the counter electrode 150 than the pixel electrodes 120A and 120B, and the potential difference EV between the shield electrode 170 and the counter electrode 150 can be easily generated. According to the liquid crystal display device 10 of the first embodiment, the impurities PM can be easily and favorably attracted to the inter-pixel area A12.

In the liquid crystal display device 10 of the first embodiment, the shield electrode 170 is provided at the position overlapping the pixel electrodes 120A and 120B in the Z direction (normal direction) along the normal of the element substrate 12. For example, when viewed along a direction parallel to the surface 126a of the insulating layer 126, a shield electrode (electrode) 170X overlaps the pixel electrode 120A and the pixel electrodes (second pixel electrodes) 120B and 120C. For example, when viewed along the X direction, a shield electrode 170Y overlaps the pixel electrodes 120A and 120B. The shield electrode 170Y overlaps the pixel electrode 120A and the pixel electrode (second pixel electrode) 120C when viewed in a direction inclined in both the X direction and the Y direction and orthogonal to the Z direction, that is, a direction along a diagonal line of the pixel electrode 120A in the plan view.

According to the liquid crystal display device 10 of the first embodiment, the potential difference EV can be generated between the shield electrode 170 and the counter electrode 150, and a potential wall can be easily formed between the pixel areas A11 of the display area A1.

In the liquid crystal display device 10 of the first embodiment, the potential LHL of the shield electrode 170 is different from the potential in response to the data signal applied to the pixel electrodes 120A and 120B.

According to the liquid crystal display device 10 of the first embodiment, the potential difference EV different from the potential difference between the pixel electrodes 120A and 120B and the counter electrode 150 is generated between the shield electrode 170 and the counter electrode 150, and the impurities PM in the pixel area A11 can be favorably captured by the electric field in the inter-pixel area A12 and the shield electrode 170.

The electronic apparatus including the projector 200 according to the first embodiment includes the liquid crystal display device 10 described above.

According to the projector 200 and the electronic apparatus of the first embodiment, since the liquid crystal display device 10 is provided, the display quality of the entire output image can be improved.

### Second Embodiment

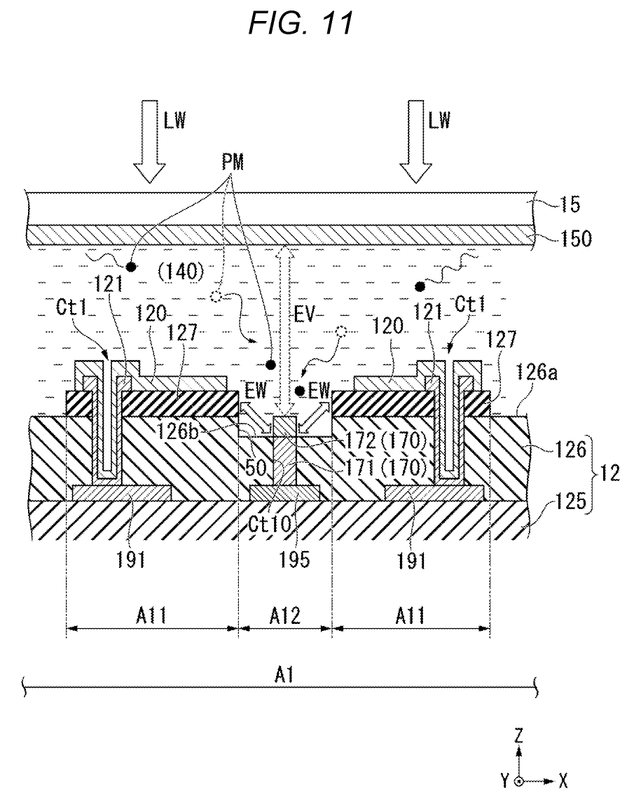

A second embodiment of the present disclosure will next be described with reference to FIG. 11. In the description of the second embodiment, the description of the contents in common with the first embodiment will be omitted, and only contents different from those in the first embodiment will be described. Further, regarding the configuration of the liquid crystal display device of the second embodiment, the configurations common to those of the liquid crystal display device 10 of the first embodiment have the same signs as the corresponding configurations of the liquid crystal display device 10 of the first embodiment, and the description thereof will be omitted.

FIG. 11 illustrates a state in which the impurities PM are captured in the display area A1 in the liquid crystal display device of the second embodiment, and is a cross-sectional view corresponding to a case cut along line B3-B4 in FIG. 5. As illustrated in FIG. 11, the insulating layer 126 in the inter-pixel area A12 of the display area A1 of the element substrate 12 is formed with a recess 50 recessed to the side opposite to the liquid crystal layer 140.

The contact hole Ct10 and the shield electrode 170 are formed in the recess 50. A recess bottom surface 126b of the recess 50 is located above, that is, in front in the Z direction of the surface of the wire 195. The surface of the base conductive layer 171 of the shield electrode 170 is located, for example, at substantially the same height as the recess bottom surface 126b. The upper conductive layer 172 of the shield electrode 170 protrudes toward the liquid crystal layer 140 more than the recess bottom surface 126b of the insulating layer 126, for example.

In the present specification, "protruding toward the liquid crystal layer 140 more than the insulating layer 126" includes a case where the end, that is, the front end in the Z direction of the shield electrode 170 protrudes toward the liquid crystal layer 140, that is, upward, forward in the Z direction with respect to the surface 126a or the recess bottom surface 126b of the insulating layer 126 by a dimension of a manufacturing error of the element substrate 12 as long as an appropriate potential difference can be generated between the shield electrode 170 and the counter electrode 150 as electrodes.

In addition, "protruding toward the liquid crystal layer 140 more than the insulating layer 126" includes a case where at least a part of the surface, that is, the end surface of the shield electrode 170 protrudes toward the liquid crystal layer 140.

In a period in which the power of the liquid crystal display device of the second embodiment is ON, the potential LCcom is applied to the counter electrode 150 of the counter substrate 15, the potential corresponding to a data signal is applied to the pixel electrodes 120 of the pixel area A11 of the display area A1 of the element substrate 12, the potential LHL is applied to the shield electrodes 170 in the inter-pixel area A12, a potential difference EV is generated between the shield electrodes 170 and the counter electrode 150, a potential difference EW is generated between the shield electrodes 170 and the pixel electrodes 120A and 120B, and an electric field is generated in the inter-pixel area A12. In the liquid crystal display device of the second embodiment, the potential difference EW can be utilized more actively than the potential difference EV, and the height of the shield electrode 170 is suppressed to be lower than that of the liquid crystal display device 10 of the first embodiment.

Since the liquid crystal display device of the second embodiment described above has the similar configuration as the liquid crystal display device 10 of the first embodiment, the liquid crystal display device of the second embodiment exerts the similar effects as those of the liquid crystal display device 10. In the liquid crystal display device of the second embodiment, the recess 50 is formed in the insulating layer 126 in the inter-pixel area A12 between the pixel electrodes 120A and 120B in the pixel area A11, and the shield electrode 170 is provided in the recess 50.

In the liquid crystal display device of the second embodiment, as described in the first embodiment, a photochemical reaction occurs in the liquid crystal layer 140, and impurities PM are generated in the pixel area A11. In the inter-pixel area A12, the potential difference EW is generated between the shield electrode 170 and the pixel electrode 120 in a plane including the X direction and the Y direction, and the impurities PM generated in the pixel area A11 adjacent to the inter-pixel area A12 are captured. As a result, the impurities PM in the pixel area A11 of the display area A1 are captured in the inter-pixel area A12 on which the irradiation light LW is not incident, the shielding of the irradiation light LW and the image light (not illustrated) by the impurities PM is prevented, and the deterioration of the display quality of the liquid crystal display device of the second embodiment is suppressed.

Also, in the liquid crystal display device of the second embodiment, the potential LHL of the shield electrode 170 is different from the potential corresponding to the data signal applied to the pixel electrodes 120A and 120B.

According to the liquid crystal display device of the second embodiment, the potential difference EW is generated between the shield electrode 170 and the pixel electrodes 120A and 120B, and the impurities PM in the pixel area A11 can be favorably captured by the electric field in the inter-pixel area A12 and the shield electrode 170.

Although not illustrated, the electronic apparatus including the projector according to the second embodiment includes the liquid crystal display device according to the second embodiment, and the display quality of the entire output image can be improved.

The preferable embodiments of the present disclosure have been described above in detail. The present disclosure is not limited to the specific embodiments, but various modifications and changes can be made within the scope of the gist of the present disclosure described in What is claimed is.

As an example, in the liquid crystal display device 10 and the liquid crystal display device of the second embodiment described above, the upper conductive layer 172 of the shield electrode 170 may be formed to be appropriately larger than the base conductive layer 171 in the plan view. The upper conductive layer 172 is patterned into a shape including the base conductive layer 171 so as to cover the end of the base conductive layer 171, whereby an overhang structure in which a part of the upper conductive layer 172 protrudes from the base conductive layer 171 in the cross-sectional view is provided. As a result, the same effects as those of the shield electrode 138 are obtained, and the capturing force when the impurities PM are captured by the shield electrode 170 is increased. Even when the liquid crystal display device 10 and the liquid crystal display device of the second embodiment are OFF, the separation of the impurities PM from the shield electrode 170 is suppressed.

In the liquid crystal display device 10 and the liquid crystal display device of the second embodiment described above, the base conductive layer 171 of the shield electrode 170 also serves as the wire 195, and the wire 195 may be omitted. In the liquid crystal display device 10 and the liquid crystal display device of the second embodiment described above, the insulating layer 127 may be omitted.

### Summary of Present Disclosure

The summary of the present disclosure will be appended below.

(Appendix 1) An electro-optical device includes a first substrate and a second substrate disposed to face each other and bonded to each other via a sealing material, a liquid crystal layer sandwiched between the first substrate and the second substrate, an insulating layer provided in a display area of the first substrate, a first pixel electrode and a second pixel electrode provided at the liquid crystal layer side of the insulating layer, a counter electrode provided on the second substrate to face the first pixel electrode and the second pixel electrode, to which a first potential is applied, and an electrode provided to protrude from the insulating layer toward the liquid crystal layer in an inter-pixel area between the first pixel electrode and the second pixel electrode in a plan view, to which a second potential different from the first potential is applied, wherein the electrode forms a step in the inter-pixel area.

According to the configuration of Appendix 1, a potential difference is generated between the electrode and the counter electrode, impurities generated in the pixel area due to irradiation of the display area with irradiation light can be captured in the inter-pixel area, and the impurities can be efficiently removed from the pixel area and deterioration in display quality of the liquid crystal display device can be suppressed as compared with a configuration in which the impurities are attracted to the non-display area around the display area as in the related art.

(Appendix 2) In the electro-optical device according to Appendix 1, the electrode protrudes toward the counter electrode side more than the first pixel electrode and the second pixel electrode.

According to the configuration of Appendix 2, the electrode is disposed closer to the counter electrode than the pixel electrode, the potential difference between the electrode and the counter electrode is easily generated, and the impurities can be easily and favorably attracted to the inter-pixel area.

(Appendix 3) In the electro-optical device according to Appendix 1 or 2, the electrode is provided at a position overlapping the first pixel electrode and the second pixel electrode in a normal direction of the first substrate.

According to the configuration of Appendix 3, a potential difference between the electrode and the counter electrode can be generated, and a potential wall can be easily formed in the inter-pixel area between the pixel areas of the display area.

(Appendix 4) In the electro-optical device according to any one of Appendices 1 to 3, in the inter-pixel area, a recess is formed in the insulating layer, and the electrode is provided in the recess.

According to the configuration of Appendix 4, a potential difference is generated between the electrode and the counter electrode, the impurities generated in the pixel area can be captured in the inter-pixel area, and the impurities can be efficiently removed from the pixel area and deterioration in display quality of the liquid crystal display device can be suppressed as compared with a configuration in which the impurities are attracted to the non-display area around the display area as in the related art.

(Appendix 5) In the electro-optical device according to any one of Appendices 1 to 4, the second potential is different from potentials of the first pixel electrode and the second pixel electrode.

According to the configuration of Appendix 5, a potential difference different from the potential difference between the pixel electrode and the counter electrode is generated between the electrode and the counter electrode, and the impurities generated in the pixel area can be captured in the inter-pixel area.

(Appendix 6) A projector includes the electro-optical device according to any one of Appendices 1 to 5.

According to the configuration of Appendix 6, the display quality of the projection image of the projector can be improved.

(Appendix 7) An electronic apparatus including the electro-optical device according to any one of Appendices 1 to 5.

According to the configuration of Appendix 7, the display quality of the output image of the electronic apparatus can be improved.

What is claimed is:

1. An electro-optical device, comprising:
a first substrate and a second substrate disposed to face each other;
a liquid crystal layer sandwiched between the first substrate and the second substrate;
an insulating layer provided at a liquid crystal layer side of the first substrate;
a first pixel electrode and a second pixel electrode provided at a liquid crystal layer side of the insulating layer;
a counter electrode provided at a liquid crystal layer side of the second substrate to face the first pixel electrode and the second pixel electrode, to which a first potential is applied; and
an electrode provided to protrude from the insulating layer toward the liquid crystal layer in an inter-pixel area between the first pixel electrode and the second pixel electrode in a plan view, to which a second potential different from the first potential is applied.

2. The electro-optical device according to claim 1, wherein
the electrode protrudes toward the counter electrode more than the first pixel electrode and the second pixel electrode.

3. The electro-optical device according to claim 1, wherein
the electrode is provided at a position overlapping the first pixel electrode and the second pixel electrode in a normal direction of the first substrate.

4. The electro-optical device according to claim 1, wherein
in the inter-pixel area, a recess is formed in the insulating layer, and the electrode is provided in the recess.

5. The electro-optical device according to claim 1, wherein
the second potential is different from potentials of the first pixel electrode and the second pixel electrode.

6. A projector, comprising the electro-optical device according to claim 1.

7. An electronic apparatus, comprising the electro-optical device according to claim 1.
